(19) United States
(12) Patent Application Publication
(10) Pub. No.: US 2009/0217899 A1
(43) Pub. Date: Sep. 3, 2009

(54) INTAKE MANIFOLD FOR INTERNAL COMBUSTION ENGINES

(75) Inventors: William R. Glidden, Whiteland, IN (US); Richard A. Maskin, Royal Oak, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: DART MACHINERY, LTD., Troy, MI (US)

(21) Appl. No.: 12/039,340

(22) Filed: Feb. 28, 2008

(51) Int. Cl. F02M 35/104

(52) U.S. Cl. 123/184.46; 123/184.47

(57) ABSTRACT

An intake manifold for an internal combustion engine that distributes a fuel-air mixture to an engine. The manifold includes a box-shaped chamber defined by at least four sidewalls. The chamber is mounted atop multiple intake runners, and opens to an intake plenum to which multiple runners are joined. The box-shaped chamber can include a mounting flange to which a substantially planar cover plate can be mounted to close the top of the box-shaped chamber. The cover plate can define at least one hole to accommodate a carburetor, throttle body or other fuel-air mixture delivery device.

### BACKGROUND OF THE INVENTION

The present invention relates to an intake manifold for use with internal combustion engines.

Most high performance internal combustion engines include an intake manifold, mounted atop the engine block and heads, which receives an fuel-air mixture from a carburetor, throttle body or other device, and distributes the fuel-air mixture through runners to multiple cylinder intake ports of the engines' cylinders. Typically, the fluid flow characteristics of an intake can dramatically affect the performance of the engine, thereby giving it better low, mid and/or high end horsepower and/or torque.

Several variables affect the flow of the fuel-air mixture from the carburetor to the engine cylinders, including the volume of the intake plenum, restrictions in the intake plenum, dead air spaces within the intake plenum, and the directness of the route of the fuel-air mixture from the carburetor to the intake runners.

A variety of manifolds have been designed to address these issues, particularly in the field of aftermarket intakes designed to improve the horsepower of V6, V8 and V10 engines; however, room for improvement remains. For example, one intake manifold used to improve peak and a range of horsepower is the tunnel ram. This intake is designed to accommodate two carburetors mounted atop separate high rise throats of the intake. The throats are tall, typically six to eight inches in height, and open directly to a single intake plenum below, to which runners are joined. In effect, the high rise throats enable the fuel to better atomize and distribute within the air of the fuel-air mixture, which typically improves peak horsepower of the engine. The tall profile of the intake, however, requires significant under-hood space. Indeed, the hood of the vehicle in which such intakes are installed usually must be modified to accommodate the intakes by cutting the hood and including a raised scoop. This, of course, raises the cost of installing such intakes on an engine, and in many case detracts from the appearance of the vehicle.

### SUMMARY OF THE INVENTION

The present invention provides a low-profile, internal combustion engine intake manifold that distributes a fuel-air mixture from a single carburetor or a single throttle body to multiple cylinders of the engine. In one embodiment, the intake manifold can include a box-shaped chamber defined by at least four sidewalls.

In another embodiment, the chamber can be mounted atop multiple intake runners, and can open to an intake plenum to which multiple runners are joined.

In yet another embodiment, the box-shaped chamber can include a mounting portion or flange to which a substantially planar, removable cover plate can be mounted to close the top of the box-shaped chamber. The cover plate can define at least one hole to accommodate a carburetor, throttle body or other fuel-air mixture delivery device.

In a further embodiment, the intake includes upper and lower portions. The lower portion can define an intake plenum, bounded by a plenum floor. This intake plenum can be in open fluid communication with runners that extend from the intake to respective intake cylinder ports of an engine. Optionally, the lower portion can also include an engine valley cover joined with the runners and/or the lower portion. This cover can be located below the plenum floor, and configured to cover an engine valley of the engine, which may be of the V-type configuration, such as V6, V8 or V10.

In another, further embodiment, the intake includes an upper portion located directly above the lower portion. This upper portion can include the box-shaped chamber. Optionally, the box-shaped chamber can be constructed from four or more side walls. Each side wall can be substantially planar, and can be joined with the other walls at corners. The box-shaped chamber can be floorless, so that it opens directly to the intake plenum to provide direct fluid communication with the runners through the intake plenum.

In yet another, further embodiment, the intake can be configured as a single plane intake. In other words, the upper and lower portions can be substantially void of any structures that separate the fuel-air mixture so that it flows to selected runners associated with cylinders on opposite sides of the engine.

The present invention provides a simple and inexpensive intake manifold producing improved horsepower output from an internal combustion engine at selected low-, medium-, or high-rpms, or a combination of the foregoing. Because the intake is of a low-profile configuration, it can easily be installed on a variety of engines without substantial concern for under-hood clearance. Further, due to the box-shaped chamber, the fuel-air mixture is provided with a short, direct route from the top of the box-chamber to the runners, which in turn, improves the desired horsepower increase.

These and other objects, advantages and features of the invention will be more readily understood and appreciated by reference to the detailed description of the invention and the drawings.

### BRIEF DESCRIPTION OF THE DRAWINGS

FIG. 1 is a perspective view of an intake manifold of one embodiment;

FIG. 2 is an exploded perspective view thereof;

FIG. 3 is a perspective view of the manifold mounted to an engine and having a carburetor joined with the manifold;

FIG. 4 is a front view of the intake manifold mounted to the engine;

FIG. 5 is a top view thereof;

FIG. 6 is a cross section view of the intake manifold taken along lines 6-6 of FIG. 5; and

FIG. 7 is a graph illustrating the horsepower improvement provided by the intake manifold of one embodiment over a conventional manifold.

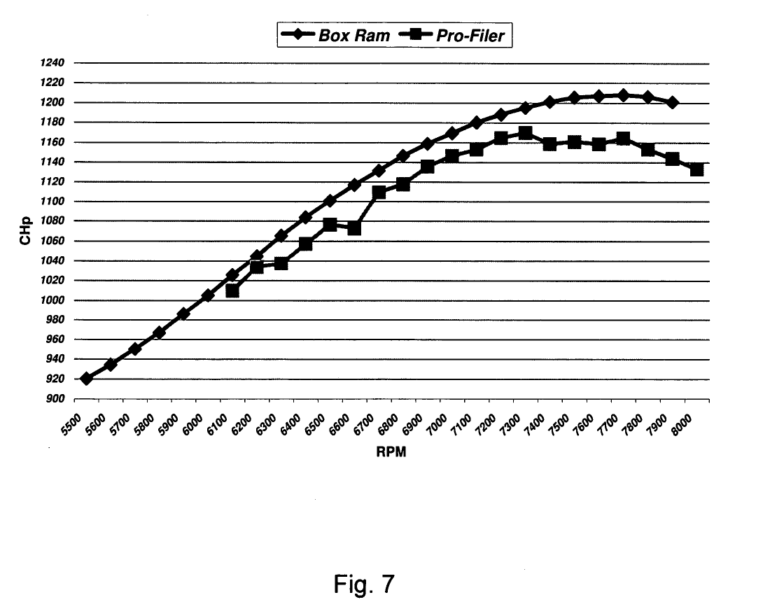

### DETAILED DESCRIPTION OF THE INVENTION

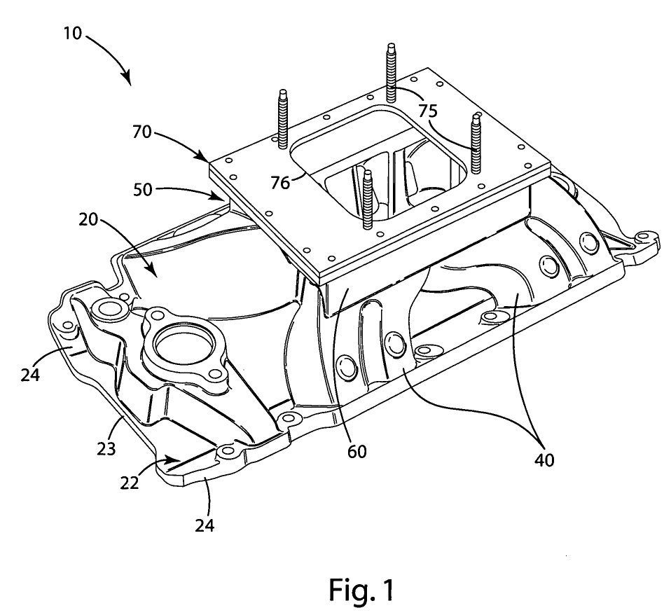

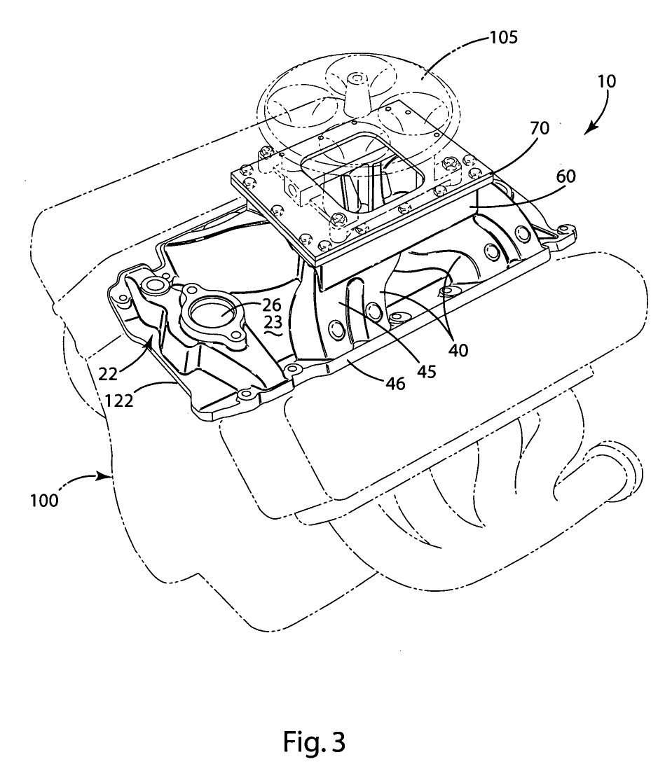

An embodiment of the intake manifold is shown in FIGS. 1-6 and generally designated 10. As shown there, the intake manifold generally can include a lower portion 20 defining an intake plenum 30 and having runners 40 joined therewith, an upper portion 50 defining a box-shaped chamber 60, and an optional removable cover 70 joined with the upper portion to close the top of the box-shaped chamber. As shown in FIG. 3, the intake 10 is joined with a V-type cylinder block engine 100, for example, a V6, V8 or V10 block; however, it is contemplated that the intake can be suitable for other types of engine configurations.

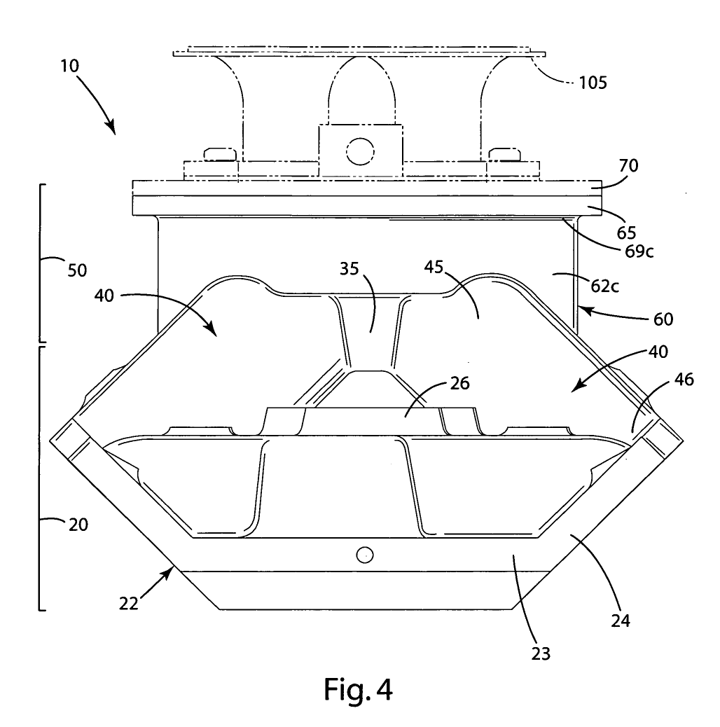

As further shown in FIGS. 3-4, the intake 10 has joined with it a single four barrel carburetor 105, and thus set up to qualify for use in single carburetor high performance drag racing events. The intake, however, can also be configured to accept a single throttle body, or a single fuel injection system as desired to accommodate other types or racing events-indeed, the intake can be configured to accommodate 2, 3 or more carburetors, throttle bodies or fuel injection systems as desired. Moreover, where the cover 70 is removed, a supercharger can be mounted directly to the intake 10, in the absence of a carburetor or throttle body.

Returning to FIGS. 1-6, the components of the intake 10 will now be described. Along its lowermost part, the lower portion 20 can optionally include an engine valley cover 22, which is configured to mount to a V-type engine, and subsequently to extend across and cover a substantial portion or all of the engine valley of that engine. In so doing, the engine valley cover 22 can effectively cover the engine valley so that all components of the engine within the valley 122 (FIG. 3) are concealed and secure. The engine valley cover 22 can include a central portion 23 and laterally projecting side flanges 24 which also extend upward at an angle relative to the central portion 23. The central portion 23 can define a distributor mount 25 and one or more coolant apertures 26 as desired. The engine valley cover 22 and its components can be joined with the engine by way of fasteners, such as bolts and the like.

The lower portion 20 further defines an intake plenum 30. This plenum 30 is generally an open, single plane plenum, void of any baffles that dissect one side of the plenum entirely from the other side of the plenum, as in a dual plane intake. The plenum can be bounded along its underside by a plenum floor 32, which can define a continuous contour surface extending from a bank of runners 40 on one side of the intake to the bank of runners on the opposite side of the intake 10. This plenum floor 32 can also be continuous with the floors 43 of each of the runners 40 as desired, or, there can be a step up or step down to the runner floors as desired.

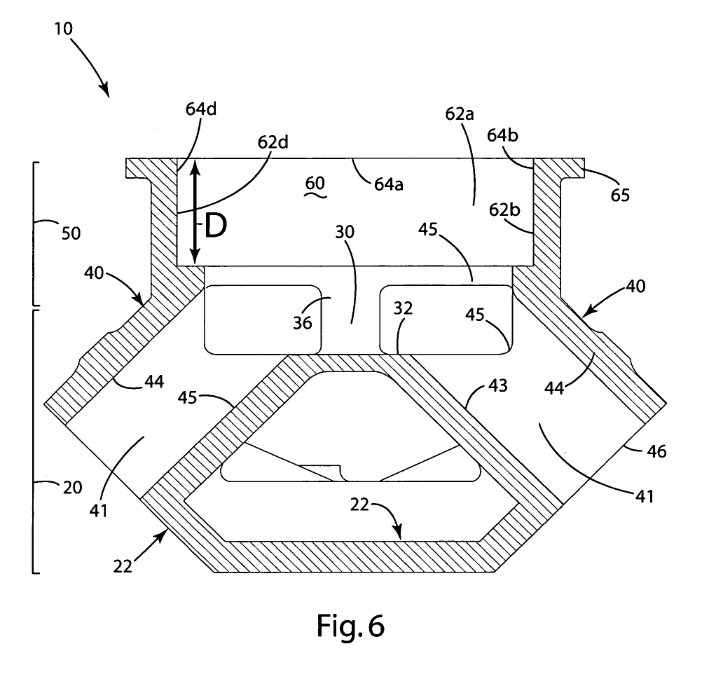

As shown in FIG. 6, the plenum floor 32 can be supported by the runners or other structure above the engine valley cover 22 a predetermined distance. This distance can range from about 1 inch to about 6 inches, optionally about 2 to about 3 inches, as the application requires. Generally, however, smaller distances can be used to retain the low profile of the intake.

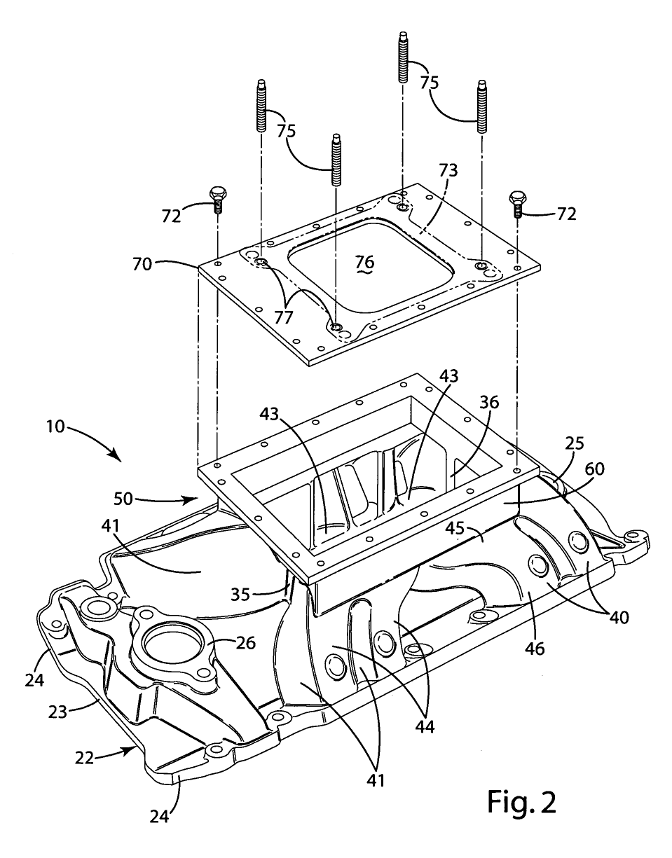

The lower portion also can include the runners 40 mentioned above. These runners can vary in number, depending on the number of cylinders in the engine. Generally, the runners 40 will be of the same number as the cylinders of the engine. As shown in FIGS. 2 and 6, each runner can include side walls 41, an upper wall 44, and a runner floor 43. Generally, the runners can be tubular, which means that they are of a hollow, elongate construction, along at least a portion thereof. Where runners are adjacent one another, the sidewalls 41 of one runner can continue into the runner of the adjacent runner, forming a sidewall of that runner as well. Each of the runners can also includes a plenum end 45 and a port end 46. The port end 46 generally can be joined with the engine valley cover 22, and in particular, one of the side flanges 24. The port end 46 can also be configured so that it aligns with a respective cylinder intake port so as to establish a fuel-air mixture flow path from the intake plenum 30 to each respective combustion cylinder of the engine 100.

The plenum end 45 of the each runner can be joined with and open directly into the intake plenum 30. As shown in FIGS. 2, 4 and 6, the intake plenum 30 generally is void of any defined side-walls, and accordingly generally is bounded by the plenum ends 45 of each of the runners along its sides. At the front and rear, the plenum can be bounded by a front wall 35 and a rear wall 36 as desired. These front and rear walls also can be continuations of side walls 41 of runners from opposite sides of the intake plenum, or separately defined walls altogether.

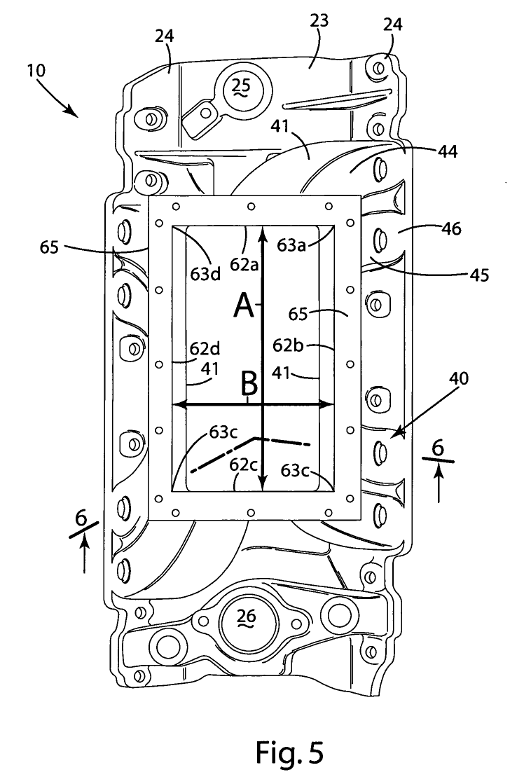

With respect to FIG. 5, the intake plenum 30 can also be configured so that portions of sidewalls 41 of certain runners project at least partially into the plenum. The precise distance of the projection into the plenum can be varied as desired, or the sidewalls can be reconfigured so that they terminate without entering the plenum.

Referring to FIGS. 4 and 5, the lower portion 20 generally transitions to the upper portion 50, which includes a box-shaped chamber 60 bounded by at least four sidewalls 62a-d. The box-shaped chamber 60 can be generally in the form of a rectangular, square or quadrilateral geometric shape. As shown, it is of a rectangular shape with its major axis A disposed along the length of the chamber, extending from the front of the intake to the rear of the intake 10. The minor axis B is disposed along the width of the chamber, extending from one side of the intake to the opposite side of the intake 10. In general, the length and the width of the chamber 60 can be pre-selected to optimize output from a specific engine or fuel system to which the intake is joined. Several suitable lengths for the major axis A can be about 10 inches to about 10.5 inches, optionally about 10.5 inches to about 11 inches, and further optionally about 11 inches to about 11.5 inches. Several suitable widths for the minor axis B can be about 5 inches to about 5.5 inches, and optionally about 5.5 inches to about 6 inches. The length and width of the box-shaped chamber can also be selected so that it falls within a pre-defined ratio, such as about 2:1 length to width. Depending on the desired engine performance, and the particular engine, the above dimensions can be modified as desired.

The box-shaped chamber side walls 62a-d. As shown can each be substantially planar, that is, each can include a generally two dimensional surface facing the interior of the box-shaped chamber 60, wherein that surface is substantially flat; however that surface can also include one or more small curvatures, undulations and/or angular sub-surfaces and still be considered substantially planar. The exterior of the sidewalls 62a-d can include corresponding features as well. The sidewalls 62 a-d can generally be of the same depth D (FIG. 6), which can range from about 1.25 inches to about 1.5 inches, and optionally about 1.5 inches to about 2 inches. These depths can provide a low-profile for intake so that it fits well in under-hood applications. In general, where the intake 10 projects at its highest-most component above the engine by less than about 7 inches to about 8 inches, optionally less than about 6 inches, the intake can be considered a low-profile intake.

The sidewalls 62a-d can also include lower wall sections, which are joined with the runners atop the upper walls 44 of the runners. In certain embodiments, the sidewalls remain uninterrupted by the runners 40, with the upper walls 44 of the runners terminating adjacent the lower section of the sidewalls 62a-d, but without forming an opening in those sidewalls 62a-d.

The box-shaped chamber 60 can also be configured to include corners 63a-d (FIG. 5), at which the sidewalls 62a-d intersect and/or are joined. These corners can be substantially right angled corners, which means that the sidewalls can intersect at angles between 80 degrees and 100 degrees, optionally about 90 degrees, and can include configurations where the inside corners 63a-d are chamfered, radiused or filleted as the application requires. Optionally, the forward corners 63a and 63c can be located over the runners 40 that correspond to the forward-most cylinders of the engine 100. Likewise, the rearward corners 63a and 63d can be located over the runners 40 that correspond to the rearward-most cylinders of the engine 100.

With reference to FIGS. 5 and 6, the box-shaped chamber 60 can be floorless, and therefore can open to the intake plenum 30 to provide fluid communication between the box-shaped chamber and the plenum, and thus the runners 40. It is noted that minor portions of the sidewalls 41 and upper walls 44 of the runners (as shown in FIG. 5) may project under the box-shaped chamber, or beyond the interior of the sidewalls 62a-d, with the chamber still being considered floorless. In addition, where those minor portions do not project under the box-shaped chamber, or beyond the into the interior of the sidewalls 62-d, the box-shaped chamber is also considered floorless.

Referring to FIGS. 4 and 6, the sidewalls 62a-d can include upper wall sections 64a-d. These upper wall sections can be modified to include a mounting portion. This mounting portion can be part of the sidewalls 62a-d themselves, or can be another component, such as the mounting flange 65 shown in the figures. Where the mounting portion is part of the sidewalls, it may simply be an upper part of the sidewalls 62a-d including a fastening element or structure for receiving a corresponding fastening element. For example, one or more of the upper wall sections can define a plurality of holes, which can optionally be threaded to receive a correspondingly threaded fastening element, such as a bolt or screw or other fastener.

Where the mounting portion is a structure such as a mounting flange 65, that flange can be integral with the sidewalls 62a-d, or can be joined with a fastening element to those sidewalls. As shown, the mounting flange 65 generally surrounds the uppermost region of the box-shaped chamber 60, projecting a distance outward from the sidewalls 62a-d in doing so. The mounting flange 65 can also be outfitted with a fastening element or structure for receiving a corresponding fastening element. For example, the flange can define a plurality of holes, which can optionally be threaded to receive a correspondingly threaded fastening element, such as a bolt or screw or other fastener. Alternatively, the mounting flange 65 can include a quick release clamp or other mechanism to efficiently engage any component desired to be joined with the mounting flange 65 or sidewalls 62a-d. Finally, while the mounting flange 65 is shown as being located on the exterior of the sidewalls 62a-d, it can alternatively by located on the interior of the sidewalls as desired. The mounting flange also can be located on either or both the interior and exterior of the sidewalls as the applications requires, even in an alternating arrangement.

The mounting portion of the intake 10 is generally configured to correspond to the optional cover 70, or to any other fuel-air introduction device that is mounted directly to the mounting portion, such as a supercharger or blower. The cover 70 button FIGS. 1, 2 and 4 generally can be configured in the same geometric shape as the box-shaped chamber, and indeed, can cover the top of the box-shaped chamber 60, closing off that top of the box-shaped chamber. If desired, a gasket (not shown) can be placed between the mounting portion of the sidewalls 62a-d and the cover 70 to create and air tight seal between these components.

The cover 70 is generally in the form of a substantially planar plate, having a thickness ranging from about ¼ inch to about 5/16 inch, optionally about ⅜ inch. By substantially planar, it is meant that the cover includes a generally two dimensional surface facing the interior of the box-shaped chamber 60, wherein that surface is substantially flat, however, that surface can also include one or more small curvatures, undulations and/or angular sub-surfaces and still be considered substantially planar. The exterior of the cover can have corresponding features as well.

The cover 70 can also define one or more fastening element apertures 71 so that it can easily be mounted to the mounting portion as desired. Optionally, the fastening elements 72 are removable so that the cover 70 is easily and quickly removable from the bolt mounting portion.

The cover 70 also can include a mounting area 73 to which a single carburetor 105 mounts. This mounting area 73 can be generally centered from front to back, and side to side of the box-shaped chamber to ensure equal distribution of the fuel-air mixture from the carburetor 105. The mounting area 73 can be of the same size and shape as the footprint of the carburetor 105 to ensure accurate positioning of the same. Moreover, the mounting area can be outfitted with connecting elements and/or corresponding holes for connecting elements to joined the carburetor with the cover 70. As shown in FIG. 2, the connecting elements 75 are studs that are threaded into stud holes 77 at locations corresponding to the bolt mounting pattern of a carburetor.

The mounting area 73 also defines a hole 76 that aligns with the barrels of the carburetor 105 so that the fuel-air mixture produced by the carburetor passes through the hole 105 directly into the box-shaped chamber 60. When other fuel-air mixture introduction devices are used, such as a throttle body or fuel injector body, the hole can be reconfigured to adequately align with the components of those devices as desired.

Referring to FIGS. 2 and 4, the mounting area 73 extends over only a portion of the box-shaped chamber 60. For example, if the surface area of the mounting area is measured, it amounts to only about ⅓ to about ½, or less of the total area of the top of the box-shaped chamber (when the cover plate is removed and the open-topped chamber is exposed). Optionally, the box-shaped chamber 60 can be said to extend beyond the mounting area 73 of the cover 70 by it extending beyond the footprint of the carburetor 105 or other fuel-air introduction device.

The components of the intake 10, including the fasteners and various portions, can be constructed from various materials including aluminum, steel, titanium, alloys, other metals and/or synthetic materials, plastic, and combinations of the foregoing.

In use, the intake 10 of the present embodiment is joined with an engine 100. Where the intake includes an engine valley cover 22, that cover is placed over the engine valley 122, with the runners 40 of the intake aligned with the appropriate intake ports of the engine 100. A gasket (not shown) can be disposed between the intake and the engine.

With the intake in place, it is joined with the engine 100 with bolts. The cover 70 of the intake, and corresponding carburetor 105 or other fuel-air introduction device can be secured to the intake 10 before or after the intake 10 is joined with the engine 100 as desired.

In the embodiment shown, the intake is designed for use with a single four barrel carburetor or throttle body 105. In this configuration, the cover 70 includes a hole or holes that accommodates only a single carburetor or throttle body. Thus, the barrels of the carburetor or the single throttle body are be aligned with that hole or holes. In other designs, the cover can include multiple holes for multiple carburetors, throttle bodies or other devices.

In operation, the carburetor 105 delivers a fuel-air mixture through the hole 105 directly into the box-shaped chamber 60. Given the relatively straight and direct route from the hole to the runners 40, as shown in FIG. 5, the atomized gas travels quickly and efficiently to those runners and subsequently to the respective engine ports and cylinders.

The box-shaped chamber 60 of the invention performs so well that it can provide a 3% increase, or 34 horsepower, increase over a conventionally configured intake on the same motor. The following example illustrates this point, but is not intended to be limiting in any way.

### EXAMPLE 1

A horsepower output comparison was performed between the intake manifold 10 and a “Pro-Filer” intake manifold, available from Pro-Filer Performance Products of New Carlisle, Ohio. The Pro-Filer manifold provided a good baseline to determine the change in horsepower due to its similar runner configuration. Indeed, in this particular example, a Pro-Filer intake was cut and the upper intake portion of the present invention, with the box-shaped chamber, was added to that intake to perform the comparison. The intakes were mounted to the same engine, a 572 cubic inch naturally aspirated gasoline engine, and dyno-tested through a variety of RPMs to determine the change in horsepower produced by the intake 10. The results of the tests are illustrated in the graph at FIG. 6. There, the Y-axis is the horsepower (CHp), and the X-axis is the RPMs of the engine over a range. Based on the testing, there was a 38.4 horsepower, or 3.3% increase in peak horsepower by the present intake (identified as “Box Ram” in the legend) over the Pro-Filer (comparing peak horsepower of 1170.0 for the Pro-Filer and 1208.4 for the present intake). In addition, there was a 34.0 horsepower, or 2.9% increase in average horsepower generated by the present intake over the Pro-Filer (comparing average horsepower of 1179.3 for the Pro-Filer and 1213.3 for the present intake). In the field of engine intakes, this increase-and generally any gain in peak horsepower, or quantified gain in average horsepower-is considered significant and unexpected.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular. Any reference to “at least one of X, Y and Z” refers to only X, only Y, only Z, and any combination of X, Y, and Z.

The embodiments of the invention in which an exclusive property or privilege is claimed are defined as follows:

1. An intake manifold for mounting at least one of a single carburetor and a single throttle body to an internal combustion engine to distribute a fuel-air mixture to a plurality of combustion cylinders in an engine, the intake manifold comprising:
a lower portion defining an intake plenum and including a plurality of tubular runners, each tubular runner having an upper runner wall, each tubular runner commonly intersecting the intake plenum, the intake plenum including a bottom bounded by a plenum floor, the intake plenum being in open fluid communication with the plurality of tubular runners, the lower portion including an engine valley cover joined with the runners, the engine valley cover being located under the plenum floor and adapted to cover an engine valley of the internal combustion engine;
an upper portion including at least four side walls, each side wall being substantially planar, each side wall including an upper wall section and a lower wall section, each side wall joined with at least two other side walls at substantially right-angled corners, the at least four side walls cooperating to define a box-shaped chamber, the upper wall sections cooperating to define a mounting portion, the box-shaped chamber being located entirely above the plurality of runners and the intake plenum, the lower wall sections of the at least four side walls terminating at the upper runner walls, the box-shaped chamber being substantially floorless so that the box-shaped chamber opens to the intake plenum to provide fluid communication between the box-shaped chamber and the plurality of runners through the intake plenum;
a substantially planar cover plate joined with the mounting portion, the substantially planar cover plate forming a cover over the box-shaped chamber, the substantially planar cover plate being removable from the mounting portion, the cover plate including a mounting area to which the at least one of the single carburetor and the single throttle body mounts, the mounting area defining a cover plate hole that aligns with the at least one of the single carburetor and the single throttle body so that the air-fuel mixture produced by the at least one of the single carburetor and the single throttle body passes through the cover plate hole into the box-shaped chamber;
wherein the box-shaped chamber extends beyond the mounting area of the substantially planar cover plate.

2. The intake manifold of claim 1 wherein the intake plenum forms a single plane intake plenum.

3. The intake manifold of claim 2 wherein the box-shaped chamber includes a width and a length, wherein the length is at least 1.25 times the width.

4. The intake manifold of claim 3 wherein the at least four sidewalls each have a height, the height being about 1.25 inches to about 1.5 inches.

5. The intake manifold of claim 4 wherein the mounting portion includes a mounting flange that projects outward from the at least four side walls, away from the box-shaped chamber.

6. The intake manifold of claim 5 wherein the mounting flange defines connecting element holes that receive connecting elements to join the cover plate to the mounting flange.

7. The intake manifold of claim 6 wherein the mounting area of the substantially planar cover plate defines mounting holes adapted to receive second connecting elements that fasten the at least one of the single carburetor and the single throttle body to the cover plate.

8. An intake manifold for an internal combustion engine that distributes a fuel-air mixture to an engine, the intake manifold comprising:
a lower portion defining an intake plenum and including a plurality of tubular runners, each tubular runner having an upper runner wall, each tubular runner commonly intersecting the intake plenum, the intake plenum including a bottom bounded by a plenum floor, the intake plenum being in open fluid communication with the plurality of tubular runners, the lower portion including an engine valley cover joined with the runners, the engine valley cover being located under the plenum floor and adapted to cover an engine valley of the internal combustion engine;
an upper portion defining a box ram bounded by four substantially planar side walls, the side walls mounted to the lower portion adjacent the upper runner wall of each tubular runner, the box ram including an open bottom portion that opens to the intake plenum to provide fluid communication between the box ram and the plurality of runners through the intake plenum; and
a removable cover joined with the upper portion above the box ram, the cover defining a hole through which a fuel-air mixture is introduced into the box ram, whereby the air fuel mixture is atomized and evenly distributed to the intake plenum and subsequently to the plurality of runners in substantially equal amounts to improve horsepower output of the engine.

9. The intake manifold of claim 8 wherein the plenum floor is substantially planar, and wherein at least one of the plurality of runners includes a side wall that projects at least partially into the intake plenum and that is joined with the plenum floor.

10. The intake manifold of claim 8 wherein the cover includes an upper surface and a lower surface, wherein the upper surface includes a mounting area to which a fuel-air device mounts to the cover, wherein the lower surface forms an upper boundary of the box ram, and wherein the lower surface extends beyond the mounting area toward the side walls.

11. The intake manifold of claim 8 comprising a flange joined with the four side walls, the flange extending outward from the side walls, the flange defining a plurality of threaded apertures.

12. The intake manifold of claim 11 wherein the cover defines a plurality of other apertures aligned with the threaded apertures of the flange.

13. The intake manifold of claim 12 wherein the cover is substantially planar and defines a single aperture that accommodates a single four barrel carburetor.

14. The intake manifold of claim 8 wherein the box ram is about 11.5 inches in length and about 6 inches in width.

15. An intake manifold for an internal combustion engine that distributes a fuel-air mixture to an engine, the intake manifold comprising:
an engine valley cover;
a plurality of runners joined with the engine valley cover;
an intake plenum at which the plurality of runners intersect, the intake plenum including an intake floor, the intake floor being located separately from and above the engine valley cover so that an open space is formed therebetween;
a box-shaped chamber defined by at least four substantially planar walls mounted atop the plurality of runners, the chamber being floorless and opening directly to the intake plenum; and
a substantially planar cover plate removably mounted atop the four walls to close a top of the box-shaped chamber except for a hole defined by the substantially planar cover plate, the hole adapted for receiving a fuel-air mixture from outside the intake manifold.

16. The intake manifold of claim 15 wherein the substantially planar cover plate defines four threaded holes, wherein four threaded fasteners are threaded into the four threaded holes and adapted to join a four barrel carburetor to the intake manifold.

17. The intake manifold of claim 15 wherein the substantially planar cover plate extends beyond the box-shaped chamber.

18. The intake manifold of claim 15 wherein the box-shaped chamber includes a length that is greater than its width.

19. The intake manifold of claim 15 wherein the substantially planar cover plate includes a forward portion extending forward of the hole, a rearward portion extending rearward of the hole, and side portions extending toward opposite sides of the hole, wherein the forward portion and rearward portion each extend at least twice the distance from the hole as one of the side portion.

20. The intake manifold of claim 15 wherein the substantially planar cover plate is rectangular in shape.
